(19) United States
(12) Patent Application Publication
(10) Pub. No.: US 2010/0097713 A1
(43) Pub. Date: Apr. 22, 2010

(54) LENS DRIVING DEVICE COMPRISING A LENS BARREL HAVING A LOWER END PORTION MAKING CONTACT WITH A BASE

(75) Inventor: Nobuyuki MIURA, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Mitsumi Electric Co. Ltd., Tokyo (JP)

(21) Appl. No.: 12/580,383

(22) Filed: Oct. 16, 2009

(30) Foreign Application Priority Data
Oct. 17, 2008 (JP) 2008-268231

(51) Int. Cl. G02B 7/04

(52) U.S. Cl. 359/824

(57) ABSTRACT

In a lens driving device including a lens barrel having an outer wall in which a male screw thread is cut, a tubular lens holder having an inner wall in which a female screw thread is cut, a driving coil fixed to the lens holder so as to position around the lens holder, a fixed portion including a magnetic field generating portion including a permanent magnet opposite to the driving coil, and an elastic member mounted to the lens holder and the fixed portion and supporting the lens holder in a direction of an optical axis shiftably so as to position the lens holder in a radial direction, the lens barrel has a lower end portion which makes contact with a base of the fixed portion in a state where the driving coil is not energized.

This application is based upon and claims the benefit of priority from Japanese Patent Application JP 2008-268231, filed on Oct. 17, 2008, the disclosure of which is incorporated herein in its entirety by reference.

### BACKGROUND OF THE INVENTION

This invention relates to a lens driving device and, in particular, to an autofocus lens driving device for use in a portable compact camera.

The portable compact camera is mounted in a camera-equipped cellular mobile phone. The portable compact camera is provided with the autofocus lens driving device. Previously, various autofocus lens driving devices have been proposed.

The autofocus lens driving device of the type described comprises a tubular lens holder for holding a lens barrel including lenses and a driving coil fixed around the lens holder. A magnetic field generating portion provided with a permanent magnet is disposed so as to be opposed to the driving coil. The magnetic field generating portion is fixed on a base. A combination of the lens barrel, the lens holder, and the driving coil serves as a movable portion of the lens driving device. On the other hand, a combination of the magnetic field generating portion and the base serves as a fixed portion of the lens driving device. In addition, the lens driving device comprises en elastic member mounted (or joined) to the lens holder and the fixed portion. The elastic member supports the lens holder in a direction of an optical axis shiftably so as to position the lens holder in a radial direction. In the lens driving device having such a structure, the lens holder is positionally adjustable to the direction of the optical axis, by energizing the driving coil, according to an electromagnetic force due to interaction between a magnetic field of the permanent magnet and an electric current flowing through the driving coil. In this case, the movable portion makes a stop (or is positioned) at a position where the electromagnetic force balances with an urging force of the elastic member.

In the camera-equipped cellular mobile phone, it is a fear that the movable portion of the lens driving device moves (or moves up or down) in the direction of the optical axis with respect to the fixed portion on account of swinging on taking it or the like. In order to prevent this, the lens driving device pushes a lower end portion of the movable portion to the base at a predetermined pushing pressure in a state where the driving coil is not energized. In other words, the lower end portion of the movable portion is pushed to the base by an urging force of the elastic member. Accordingly, the lower end portion of the movable portion is put into a state where it is pushed to the base until the above-mentioned electromagnetic force due to the electric current flowing through the driving coil is greater than the above-mentioned urging force. A minimum value of the electric current flowing through the driving coil to generate such an electromagnetic force greater than the above-mentioned urging force is called a starting current value in this technical field. Accordingly, by flowing an electrical current larger than the starting current value through the driving coil, it is possible to detach the lower end portion of the movable portion from the base. In order to restrain unevenness of performance (operating characteristics) of the lens driving device, it is necessary to make the above-mentioned pushing pressure (the urging force) constant.

Japanese Unexamined Patent Application Publication No. 2008-122643 (JP-A 2008-122643) (which will be also called a first patent document) discloses a lens driving device which is capable of adjusting the above-mentioned pushing pressure (an urging force) at a constant with simple structure. The lens driving device disclosed the first patent document comprises a holder supporting member which abuts on a lower end portion of the lens holder at a predetermined pushing pressure in a state where the lens holder is not driven (i.e. in a state where the driving coil is not energized). In addition, a joined position of the holder supporting member with respect to a lower fixing member (a base) is adjustable by means of a screw mechanism or sliding movement.

The above-mentioned lens driving device disclosed in the first patent document is disadvantageous in that the number of parts increases because the lens supporting member is required as a separate body for the lower fixing member (the base).

### SUMMARY OF THE INVENTION

It is therefore an exemplary object of the present invention to provide a lens driving device which is capable of adjusting a pushing pressure (an urging force) of an elastic member without increasing the number of parts.

Other objects of this invention will become clear as the description proceeds.

On describing the gist of an exemplary aspect of this invention, it is possible to be understood that a lens driving device comprises a lens barrel having an outer wall in which a male screw thread is cut and a tubular lens holder having an inner wall in which a female screw thread is cut. The tubular lens holder holds the lens barrel by screwing the male screw thread to the female screw thread. A driving coil is fixed to the lens holder so as to position around the lens holder. A fixed portion is fixed on a base. The fixed portion comprises a magnetic field generating portion including a permanent magnet opposite to the driving coil. An elastic member is mounted to the lens holder and the fixed portion. The elastic member supports the lens holder in a direction of an optical axis shiftably so as to position the lens holder in a radial direction. Whereby, the lens holder is positionally adjustable to the direction of the optical axis, by energizing the driving coil, according to an electromagnetic force due to interaction between a magnetic field of the permanent magnet and an electric current flowing through the driving coil. According to the exemplary aspect of this invention, the lens barrel has a lower end portion which makes contact with the base in a state where the driving coil is not energized.

### BRIEF DESCRIPTION OF THE DRAWING

FIG. 1 is a schematic sectional view of an internal main portion of a related lens driving device;

FIG. 2 is a schematic sectional view of an internal main portion of a lens driving device according to an exemplary embodiment of the present invention; and

FIG. 3 is a schematic sectional view for use in describing a method of adjusting an urging force of an elastic member in a state where a driving coil is not activated in the lens driving device illustrated in FIG. 2.

### DESCRIPTION OF THE PREFERRED EMBODIMENT

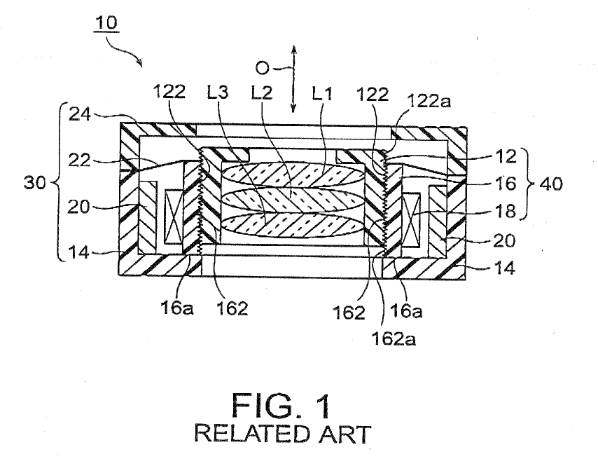

Referring to FIG. 1, a related lens driving device 10 will be described at first in order to facilitate an understanding of the present invention. FIG. 1 is a schematic sectional view of an internal main portion of the lens driving device 10. In the example being illustrated in FIG. 1, an up-and-down direction is a direction of an optical axis O of a lens.

However, in an actual use situation, the direction of the optical axis O, namely, the up-and-down direction becomes a fore-and-aft direction. In other words, an upper direction becomes a front direction while a lower direction becomes a rear direction.

The illustrated lens driving device 10 is mounted to a camera-equipped cellular mobile phone which is enabled to perform automatic focusing. The lens driving device 10 is for moving a lens barrel 12 including a plurality of lenses L1, L2, and L3 in the direction of the optical axis O. The lens driving device 10 comprises an actuator base 14 which is disposed in a lower side in the direction of the optical axis O (the up-and-down direction). Although illustration is not made, the actuator base 14 has a lower portion on which an image pickup device disposed on a board is mounted. The image pickup device picks up a subject image formed by the lens barrel 12 to convert it into an electric signal. The image pickup device may, for example, comprise a CCD (charge coupled device) type image sensor, a CMOS (complementary metal oxide semiconductor) type image sensor, or the like. Accordingly, a camera module comprises a combination of the lens driving device 10, the board, and the image pickup device.

The lens driving device 10 comprises a tubular lens holder 16 for holding the lens barrel 12, a driving coil 18 fixed to the lens holder 16 so as to position around the lens holder 16, a fixed portion 30 which is fixed to the actuator base 14 and which comprises a magnetic field generating portion including a permanent magnet 20 opposite to the driving coil 18, an elastic member 22 mounted to the lens holder 16 and the fixed portion 30, and a cover 24. The elastic member 22 supports the lens holder 16 in the direction of the optical axis O shiftably so as to position the lens holder 16 in a radial direction. The magnetic field generating portion comprises a yoke (not shown).

A combination of the lens barrel 12, the lens holder 16, and the driving coil 18 serves as a movable portion 40 of the lens driving device 10. On the other hand, a combination of the magnetic field generating portion including the permanent magnet 20, the actuator base 14, and the cover 24 serves as the fixed potion 30 of the lens driving device 10.

The lens holder 16 has an inner wall 162 in which a female screw thread 162a is cut. On the other hand, the lens barrel 12 has an outer wall 122 in which a male screw thread 122a screwed in the above-mentioned female screw thread 162a is cut. In a case of fitting the lens barrel 12 to the lens holder 16, it includes the steps of rotating the lens barrel 12 with respect to the lens holder 16 around the optical axis O to screw it along the direction of the optical axis O thereby accommodating the lens barrel 12 in the lens holder 16, and of connecting them to each other via an adhesive agent or the like.

In the lens driving device 10 having such a structure, by energizing the driving coil 18, it is possible to positionally adjust the lens holder 16 (the lens barrel 12) in the direction of the optical axis O according to an electromagnetic force due to interaction between a magnetic field of the permanent magnet 20 and an electric current flowing through the driving coil 18. In this event, the movable portion 40 makes a stop (or is positioned) at a position where the electromagnetic force balances with an urging force of the elastic member 22.

In the camera-equipped cellular mobile phone, it is a fear that the movable portion 40 of the lens driving device 10 moves (or moves up or down) in the direction of the optical axis O with respect to the fixed portion 30 on account of swinging on taking it or the like. In order to prevent this, the lens driving device 10 pushes a lower end portion of the movable portion 40 to the actuator base 14 at a predetermined pushing pressure in a state where the driving coil 18 is not energized. In other words, the lower end portion of the movable portion 40 is pushed to the actuator base 14 by an urging force of the elastic member 18. Accordingly, the lower end portion of the movable portion 40 is put into a state where it is pushed to the actuator base 14 until the above-mentioned electromagnetic force due to the electric current flowing through the driving coil 18 is greater than the above-mentioned urging force.

A minimum value of the electric current flowing through the driving coil 18 to generate such an electromagnetic force greater than the above-mentioned urging force is called a starting current value in this technical field. Accordingly, by flowing an electrical current larger than the starting current value through the driving coil 18, it is possible to detach the lower end portion of the movable portion 40 from the actuator base 14. In order to restrain unevenness of performance (operating characteristics) of the lens driving device 10, it is necessary to make the above-mentioned pushing pressure (the urging force) constant.

In the lens driving device 10 illustrated in FIG. 1, the lens holder 16 has a lower end portion 16a which abuts against (makes contact with) the actuator base 14 in a state where the driving coil 18 is not energized. That is, in the state where the driving coil 18 is not energized, the lower end portion 16a of the lens holder 16 on which an end portion of the elastic member 22 is fixed is disposed so as to make contact with the actuator base 14 of the fixed portion 30.

It is therefore impossible to adjust the urging force (the pushing pressure) of the elastic member 22. In addition, the urging force (the pushing pressure) of the elastic member 22 varies due to the unevenness of dimensional accuracy and assembly accuracy in each part of the lens driving device 10. As a result, the lens driving device 10 is disadvantageous in that unevenness of performance (operating characteristics) of the lens driving device 10 becomes larger.

In order to resolve such problems, the lens driving device disclosed in the above-mentioned first patent document (JP-A 2008-122643) comprises a holder supporting member which abuts on a lower end portion 16a of the lens holder 16 at a predetermined pushing pressure in a state where the lens holder 16 is not driven (i.e. in a state where the driving coil 18 is not energized). In addition, a joined position of the holder supporting member with respect to a lower fixing member (the actuator base 14) is adjustable by means of a screw mechanism or sliding movement.

However, the lens driving device disclosed in the first patent document is disadvantageous in that the number of parts increases because the lens supporting member is required as a separate body for the lower fixing member (the actuator base 14), as mentioned in the preamble of the instant specification.

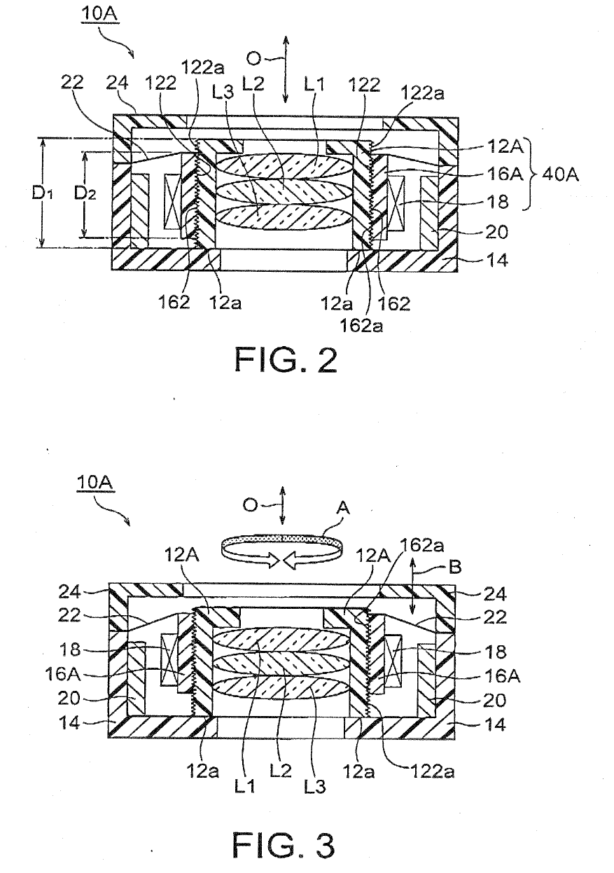

Referring to FIG. 2, the description will proceed to a lens driving device 10A according to an exemplary embodiment of this invention. FIG. 2 is a schematic sectional view of an internal main portion of the lens driving device 10A. In the example being illustrated in FIG. 2, an up-and-down direction is a direction of an optical axis O of a lens. However, in an actual use situation, the direction of the optical axis O, namely, the up-and-down direction becomes a fore-and-aft direction. In other words, an upper direction becomes a front direction while a lower direction becomes a rear direction.

The illustrated lens driving device 10A is similar in structure and operation to the related lens driving device 10 illustrated in FIG. 1 except that the movable portion is different from that illustrated in FIG. 1. The movable portion is therefore depicted at 40A. The same reference symbols are attached to those having functions similar to those illustrated in FIG. 1, differences alone will be later described in order to simplify their explanation.

The illustrated movable portion 40A is similar in structure to the movable portion 40 illustrated in FIG. 1 except that the lens barrel and the lens holder are different from those illustrated in FIG. 1. The lens barrel and the lens holder are therefore depicted at 12A and 16A, respectively.

In the lens driving device 10 illustrated in FIG. 1, the lower end portion 16a of the lens holder 16 makes contact with (or abuts against) the actuator base 14 in the state where the driving coil 18 is not energized. On the other hand, in the lend driving device 10A illustrated in FIG. 2, the lens barrel 12A has a lower end portion 12a which makes contact with (or abuts against) the actuator base 14 in the state where the driving coil 18 is not energized.

That is, modification (deformation) is made so that the lens barrel 12A has a length D₁ in the direction of the optical axis O that is longer than that of lens barrel 12 in the direction of the optical axis O and so that the lens holder 16A has a length D₂ in the direction of the optical axis O that is shorter than that of the lens holder 16 in the direction of the optical axis O. In the example being illustrated, the length D₁ of the lens barrel 12A in the direction of the optical axis O is longer than the length D₂ of the lens holder 16A in the direction of the optical axis O, namely, D₁>D₂.

Referring to FIG. 3, description will be made as regards a method of adjusting the urging force of the elastic member 22 in the state where the driving coil 18 is no energized in the lens driving device 10A illustrated in FIG. 2.

In the manner which is described above, the male screw thread 122a is cut in the outer wall 122 of the lens barrel 12A while the female screw thread 162a in which the male screw thread is screwed is cut in the inner wall 162 of the lens holder 16A.

First, in the state where the lower end portion 12a of the lens barrel 12A makes contact with the actuator base 14 of the fixed portion 30, the lens barrel 12A is rotated with respect to the lens holder 16A around the optical axis O as shown in an arrow A of FIG. 3. Thereby, the lens holder 16A moves in the direction of the optical axis O as shown in an arrow B of FIG. 3. Thereby, a warp amount of the elastic member 22 is changed to adjust the urging force of the elastic member 22 to a desired value.

Accordingly, it is possible to adjust the urging force of the elastic member 22 without increasing the number of parts. Inasmuch as the urging force of the elastic member 22 can be adjusted, it is possible to stabilize the operating characteristics of the lens driving device 10A. In other words, it is possible to restrain unevenness of the operating characteristics of the lens driving device 10A.

In the lens driving device according to the exemplary aspect of this invention, the lens barrel preferably has a length in the direction of the optical axis that is longer than that of the lens holder in the direction of the optical axis.

According to this invention, a method, in the above-mentioned lens driving device, is of adjusting an urging force of the elastic member in the state where the driving coil is not energized. The method comprises rotating the lens barrel with respect to the lens holder around the optical axis in a state where the lower end portion of the lens barrel makes contact with the base of the fixed portion to move the lens holder in the direction of the optical axis, and thereby changing an warp amount of the elastic member to adjust the urging force of the elastic member.

An exemplary advantage according to the invention is that it is possible to adjust the urging force (the pushing pressure) of the elastic member without increasing the number of parts because the lower end portion of the lens barrel makes contact with the base in the state where the driving coil is not energized.

While this invention has been particularly shown and described with reference to the exemplary embodiment thereof, the invention is not limited to the embodiment. It will be understood by those of ordinary skill in the art that various changes in form and details may be therein without departing from the spirit and scope of the present invention as defined by the claims.

What is claimed is:

1. A lens driving device comprising:
a lens barrel having an outer wall in which a male screw thread is cut;
a tubular lens holder having an inner wall in which a female screw thread is cut, said tubular lens holder holding said lens barrel by screwing the male screw thread to the female screw thread;
a driving coil fixed to said lens holder so as to position around said lens holder;
a fixed portion fixed on a base, said fixed portion comprising a magnetic field generating portion including a permanent magnet opposite to said driving coil; and
an elastic member mounted to said lens holder and said fixed portion, said elastic member supporting said lens holder in a direction of an optical axis shiftably so as to position said lens holder in a radial direction, whereby said lens holder is positionally adjustable to the direction of the optical axis, by energizing said driving coil, according to an electromagnetic force due to interaction between a magnetic field of said permanent magnet and an electric current flowing through said driving coil,
wherein said lens barrel has a lower end portion which makes contact with said base in a state where said driving coil is not energized.

2. The lens driving device as claimed in claim 1, wherein said lens barrel has a length in the direction of said optical axis that is longer than that of said lens holder in the direction of said optical axis.

3. A method, in the lens driving device as claimed in claim 1, of adjusting an urging force of said elastic member in the state where said driving coil is not energized, said method comprising:
rotating said lens barrel with respect to said lens holder around said optical axis in a state where the lower end portion of said lens barrel makes contact with the base of said fixed portion to move said lens holder in the direction of said optical axis; and
thereby changing an warp amount of said elastic member to adjust the urging force of said elastic member.
